(19) United States
(12) Patent Application Publication
(10) Pub. No.: US 2016/0023190 A1
(43) Pub. Date: Jan. 28, 2016

(54) OXYGEN CARRYING MATERIALS AND METHODS FOR MAKING THE SAME

(71) Applicant: OHIO STATE INNOVATION FOUNDATION, Columbus,, OH (US)

(72) Inventors: Liang-Shih Fan, Columbus, OH (US); Zhenchao Sun, Columbus, OH (US)

(21) Appl. No.: 14/774,727

(22) PCT Filed: Mar. 13, 2014
(86) PCT No.: PCT/US2014/026071

§ 371 Date: Sep. 11, 2015

Related U.S. Application Data
(60) Provisional application No. 61/779,070, filed on Mar. 13, 2013.

(51) Int. Cl. B01J 23/78; B01J 23/34; B01J 37/16; B01J 35/02; B01J 37/08; B01J 37/12

(52) U.S. Cl. CPC B01J 23/78; B01J 37/08; B01J 37/12; B01J 37/16; B01J 35/02; B01J 35/023; B01J 23/34

(57) ABSTRACT

A method for producing an oxygen carrying material may include forming a mixture that includes powders of active mass precursor, support material precursor, and inert structure precursor, and producing the oxygen carrying material by heating the mixture at a temperature of greater than 1300° C. for a time sufficient to sinter the inert structure precursor to form a high-strength inert structure. The inert structure precursor may be one or more refractory ceramic components.

### CROSS REFERENCE TO RELATED APPLICATIONS

This application claims priority to U.S. Provisional Patent Application No. 61/779,070, filed Mar. 13, 2013, entitled “High Reactivity High Reactivity and High Recyclability Composite Oxygen Carrier Particles with Enhanced Strength in Continuous Reduction and Oxidation Reactions” (Attorney Docket OSU 0079 MA), the teachings of which are incorporated by reference herein.

### BACKGROUND ART

1. Field

The present disclosure relates to oxygen carrying materials, and specifically to oxygen carrying materials containing one or more metal oxides.

2. Technical Background

There is a constant need for clean and efficient energy generation systems. Most of the commercial processes that generate energy carriers such as steam, hydrogen, synthesis gas (syngas), liquid fuels and/or electricity are based on fossil fuels. Furthermore, the dependence on fossil fuels is expected to continue in the foreseeable future due to the lower costs compared to renewable sources. Currently, the conversion of carbonaceous fuels such as coal, natural gas, and petroleum coke is usually conducted through a combustion or reforming process. However, combustion of carbonaceous fuels, especially coal, is a carbon intensive process that emits large quantities of carbon dioxide to the environment. Sulfur and nitrogen compounds are also generated in this process due to the complex content in coal.

Traditionally the chemical energy stored inside coal has been utilized by combustion with O₂, with CO₂ and H₂O as products. Similar reactions can be carried out if instead of oxygen, an oxygen carrying material is used in a chemical looping process. For example, metal oxides such as Fe₂O₃ can act as suitable oxygen carrying materials. However, unlike combustion of fuel with air, there is a relatively pure sequestration ready CO₂ stream produced on combustion with metal oxide carriers. The reduced form of metal oxide may then be reacted with air to liberate heat to produce electricity or reacted with steam to form a relatively pure stream of hydrogen, which can then be used for a variety of purposes.

One of the problems with chemical looping systems has been the metal/metal oxide oxygen carrying material. For example, iron in the form of small particles may degrade and break up in the reactor due to their lack of mechanical strength. Iron oxide has little mechanical strength as well. After only a few redox cycles, the activity, oxygen carrying capacity, and strength of the metal/metal oxide may decline considerably. Replacing the oxygen carrying material with additional fresh metal/metal oxide makes the process more costly.

As demands increase for cleaner and more efficient systems of converting fuel, the need arises for improved systems, and system components therein, which will convert fuel effectively, while reducing pollutants.

### SUMMARY OF INVENTION

Without being bound by theory, it is believed that higher heating temperatures, such as for example, at least greater than 1100° C., sinters inert precursor materials of an oxygen carrying material into a high-strength inert structure which imparts increased strength upon the oxygen carrying material also allows for acceptable reactivity for use in oxidation and reduction reactions.

According to one embodiment, a method for producing an oxygen carrying material may comprise forming a mixture and heating the mixture at a temperature of greater than 1300° C. In another embodiment, the heating may be at a temperature of between about 1100° and about 1400° C. The mixture may comprise powders of active mass precursor, support material precursor, and inert structure precursor. The active mass precursor may comprise metals, metal oxides, or combinations thereof. The support material precursor may comprise one or more components selected from the group consisting of metals, ceramics, metal oxides, metal carbides, metal nitrates, metal halides, clays, ores, and combinations thereof. The inert structure precursor may comprise one or more refractory ceramic components. The refractory ceramic components may be selected from the group consisting of silicon carbide, calcium aluminate, magnesium aluminate, aluminum silicate, chromium sulfate, magnesium oxide, aluminum silicate, magnesium silicate, and combinations thereof. The active mass precursor, the support material precursor, and the inert structure precursor may be different compositionally. The heating may be for a time sufficient to sinter the inert structure precursor to form a high-strength inert structure.

In another embodiment, an oxygen carrying material may comprise an active mass, a support material, and a high-strength inert structure. The active mass may comprise metals, metal oxides, or combinations thereof. The support material may comprise one or more components selected from the group consisting of metals, ceramics, metal oxides, metal carbides, metal nitrates, metal halides, clays, ores, and combinations thereof. The high-strength inert structure may comprise one or more refractory ceramic components in the form of a high-density solid framework operable to impart mechanical strength to the oxygen carrying material. The one or more refractory ceramic components is selected from the group consisting of silicon carbide, calcium aluminate, magnesium aluminate, aluminum silicate, chromium sulfate, magnesium oxide, aluminum silicate, magnesium silicate, and combinations thereof.

Additional features and advantages of the oxygen carrying materials and methods and processes for manufacturing the same will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF DRAWINGS

The following detailed description of specific embodiments of the present disclosure can be best understood when read in conjunction with the following drawings, where like structure is indicated with like reference numerals and in which:

FIG. 1 is a schematic illustration of a system for converting fuel, according to one or more embodiments described herein;

FIG. 2 is a schematic illustration of another system for converting fuel, according to one or more embodiments described herein;

FIG. 3 is a chart illustrating compression strength for oxygen carrying particles before and after 200 redox cycles, according to one or more embodiments described herein;

FIG. 4 is a chart illustrating reactivity of oxygen carrying particles through 200 redox cycles, according to one or more embodiments described herein;

FIG. 5 is a micrograph of calcium aluminate particles sintered at 1400° C.;

FIG. 6 is a zoomed in view of the image of FIG. 5;

FIG. 7 is a micrograph of calcium aluminate particles sintered at 900° C.; and

FIG. 8 is a zoomed in view of the image of FIG. 7.

### DESCRIPTION OF EMBODIMENTS

Reference will now be made in detail to various embodiments of oxygen carrying materials, and methods for producing the same, examples of which are schematically depicted in the figures. Various embodiments of the oxygen carrying materials, and methods for forming the same, will be described in further detail herein with specific reference to the appended drawings.

In one embodiment, the oxygen carrying material may comprise an active mass, such as a metal oxide, which may store, receive, or donate one or more oxygen atoms, thus changing oxidation states during reaction. Such oxygen carrying materials may be useful in chemical looping systems. For example, in a chemical looping system, the oxygen carrying material may undergo alternating oxidation reactions and reduction reactions in a cyclic pattern, where with each reaction the oxygen carrying material either receives or donates one or more oxygen atoms and thus changes oxidation states. In some embodiments, the oxygen carrying material may be in the form of a particle, such as a particle having a diameter of between about 0.5 mm and about 10 mm. Such a particle embodiment may cycle through a chemical looping system, such as by moving between an oxidation reactor and a reduction reactor. However, while the oxygen carrying materials described herein are sometimes described as in a particle form or a plurality of particles, the oxygen carrying materials may be of any shape and size.

In addition to the active mass, the oxygen carrying material may comprise a high-strength inert structure. As used herein, a high-strength inert structure is a solid framework structure of one or more materials that are inert to oxidation and reduction reactions, or substantially inert to oxidation and reduction reactions such as having a very low reactivity unsuitable for chemical looping systems, and highly densified through sintering at relatively high temperatures, such as those above about 1100° C. Without being bound by theory, it is believed that the high sintering temperatures fuse the inert precursor particles/powders into a highly-densified solid structure. The high-strength inert structure may serve to form a strong, solid framework for the oxygen carrying particle which may impart structural integrity to the oxygen carrying particle. As described herein, the high-strength support structure may be referred to as a frame or framework. The high-strength inert structure may be formed by sintering the oxygen carrying material at elevated temperatures, such as at least about 1100° C., 1200° C., 1300° C., or even higher depending upon the material of the high-strength inert structure. Without being bound by theory, it is believe that the elevated sintering temperatures serve to form a strong framework structure that imparts strength to the oxygen carrying material while allowing for the active mass to effectively function as a porous reactant. The oxygen carrying materials described herein may have high reactivity, high recyclability, and/or high physical strength for applications in continuous reduction and oxidation chemical looping reactor systems.

In some embodiments, the oxygen carrying materials described herein may have superior performance, particularly in mechanical strength over cyclic reactions, to conventional oxygen carrying materials. As used herein, “conventional” oxygen carrying materials or particles refer to non-sintered or low temperature sintered oxygen carrying materials, such as those described in PCT Application No. PCT/US2012/37557. Conventional oxygen carrying materials are prepared by sintering at relatively low temperatures, such as about 1000° C., or less. Relatively high sintering temperatures were not utilized because if the sintering temperature is relatively high, the oxygen carrying material is densified to a higher extent, and thus, the surface area and pore volume are significantly reduced. As such, low temperature sintering was utilized, as an over-densified oxygen carrying particle is not favorable due to its lower reactivity in the reactions with reducing and oxidizing reactants. Thus, conventional oxygen carrying particle synthesis avoids high temperature range sintering (e.g. greater than 1100° C.) to preserve the pore structure and high surface area of the oxygen carrying particle as a whole. Without being bound by theory, it is believed that when the sintering temperature is relatively low, the inert structure precursor material, especially high melting-point refractory materials, cannot fuse together to a high degree to form the desired strong ceramic frame, or alternatively, a ceramic frame is formed that is not sufficiently strong enough to maintain the particle's strength after cyclic redox reactions.

Conventional oxygen carrying particle preparation techniques may not achieve high physical strength along with acceptable reactivity and recyclability, due to the concern for morphological deterioration by high temperature sintering. The oxygen carrying materials described herein achieve high physical strength by sintering an inert material into a strong inert frame, but also maintaining sufficient reactivity, as the sintered active mass may be activated by an activation step and/or may be synthesized with a pore forming material.

The oxygen carrying material generally may comprise an active mass and a high-strength inert structure. The active mass may serve to donate oxygen to the fuel for its conversion, thus changing oxidation states with the loss or gain of one or more oxygen atoms. The active mass also may accept the oxygen from air/steam to replenish the oxygen lost. In one embodiment, the primary active mass may comprise a metal or metal oxide of Fe, Co, Ni, Cu, Mo, Mn, Sn, Ru, Rh, or combinations thereof. In another embodiment, the primary active mass may comprise a metal or metal oxide of Fe, Cu, Ni, Mn, or combinations thereof. In yet another embodiment, the primary active mass may comprise a metal or metal oxide of Fe, Cu, or combinations thereof. In one embodiment, the oxygen-carrying particles may contain between about 10% and about 90% by mass of the active mass material. In another embodiment, the oxygen-carrying particles may contain between about 15% and about 70%, or about 20% to about 50%, about 40% to 60%, or about 10% to about 30% by mass of the active mass material.

In one embodiment, the oxygen carrying material may comprise a high-strength inert structure. The high-strength inert structure may be a homogeneous body within the oxygen carrying particle, when, for example, only one inert material is incorporated. The high-strength inert structure may comprise one or more chemical compositions sintered to a strong, high-density state. As used herein, “highly-densified” or a “high-density state” refers to a solid state of a sintered body wherein the precursor particles are bonded with one another to a degree sufficient to impart bulk physical integrity. On the other hand, a non highly-densified sintered body, such as one only partially sintered, is less dense, such that the sintered precursor powders are not bonded to a sufficient degree to impart bulk physical integrity upon the body, such as, for example, to a degree where the particle does not crumble after just a few redox cycles or exposure to reactor system conditions. Such non highly-densified sintered bodies may crumble to the touch and do not constitute a bulk body that may withstand even minor physical forces. In another embodiment, the high-strength inert structure may consist essentially of one or more chemical compositions sintered to a high-density state. The high-strength inert structure may form a strong, high-density solid framework for the oxygen carrying particle which may impart structural integrity to the oxygen carrying particle. The high-strength inert structure may be highly-densified through a sintering process, such as sintering at a time and temperature sufficient to form a solid framework for the oxygen carrying particle. In one embodiment, the oxygen carrying particle may comprise more than one high-strength inert structure, such as for example, if two or more bulk structures form in the particle that are not directly connected through high-density sintering.

The high-strength inert structure may comprise a metal, metal oxide, metal carbides, metal nitrates, or metal halides of Li, Be, B, Na, Mg, Al, Si, K, Ca, Sc, Ti, V, Cr, Mn, Co, Zn, Ga, Ge, Rb, Sr, Y, Zr, Nb, Mo, Cd, In, Sn, Sb, Cs, Ba, La, Ce, Th. In another embodiment, the high-strength inert structure may comprise a ceramic or clay material such as, but not limited to, aluminates, aluminum silicates, aluminum phyllosilicates, silicates, diatomaceous earth, sepiolite, kaolin, bentonite, and combinations thereof. In yet another embodiment, the high-strength inert structure may comprise an alkali or alkaline earth metal salt of a ceramic or clay material. In one embodiment, the oxygen carrying material contains between about 5% and about 90% by mass of the high-strength inert structure. In another embodiment, the oxygen carrying material contains between about 15% and about 70%, or about 15% to 55% by mass of the high-strength inert structure.

In one embodiment, the high-strength inert structure may comprise one or a mixture of one or more refractory ceramics. Generally, a refractory ceramic may retains its strength at high temperatures, such as above about 538° C. (1000° F.). Generally, these materials require relatively high sintering temperatures, such as greater than 1100° C., greater than 1150° C., greater than 1200° C., greater than 1250° C., greater than 1300° C., or even greater than 1350° C. Examples of refractory ceramics include, but are not limited to, silicon carbide, calcium aluminate, magnesium aluminate, aluminum silicate, chromium sulfate, magnesium oxide, aluminum silicate, and magnesium silicate.

In another embodiment, the oxygen carrying material may comprise a support material in addition to the active mass and the high-strength inert structure. The active mass, or other catalytic or reactive material of the oxygen carrying material may be coupled to the support material. Without being bound by theory, it is believed that the addition of the support material may facilitate improved reactivity and strength of the oxygen carrying material. In one embodiment, the oxygen carrying material contains between about 1% and about 35% of the support material. In one embodiment, the support material may comprise a metal, metal oxide, metal carbides, metal nitrates, or metal halides of Li, Be, B, Na, Mg, Al, Si, K, Ca, Sc, Ti, V, Cr, Mn, Co, Zn, Ga, Ge, Rb, Sr, Y, Zr, Nb, Mo, Cd, In, Sn, Sb, Cs, Ba, La, Ce, Th. In another embodiment, the support material may comprise a ceramic or clay material such as, but not limited to, aluminates, aluminum silicates, aluminum phyllo silicates, silicates, diatomaceous earth, sepiolite, kaolin, bentonite, and combinations thereof. In yet another embodiment, the support material may comprise an alkali or alkaline earth metal salt of a ceramic or clay material. In yet another embodiment, the support material may comprise a naturally occurring ore, such as, but not limited to, hematite, ilmenite, or wustite. In one embodiment, the oxygen carrying material contains between about 5% and about 90%, about 10% to about 70%, or about 20% to about 60% by mass of the support material.

To form the oxygen carrying materials, an active mass precursor, inert structure precursor, and other optional additives may first be well-mixed by one or a combination of synthesis techniques including, but not limited to, mechanical mixing, slurry mixing, impregnation, sol-gel, co-precipitation, and solution combustion. Mixture additives include support materials discussed herein, which may be present in the oxygen carrying particles, as well as other additives such as pore producing additives which may be liberated or otherwise chemically altered during sintering. As described herein, “precursor” materials refer to materials of the oxygen carrying material prior to sintering. These precursor materials may have the same chemical composition once sintered, but are generally in a powder form that does not retain bulk strength.

Pore forming materials may be added to generate pores in the oxygen carrying materials, which may improve the reactivity and recyclability of the oxygen carrying materials. Due to the relatively high sintering temperature, the oxygen carrying materials described herein may densify the active mass which may lead to lower reactivity of the oxygen carrying particles in, for example, chemical looping reactions. Pore forming materials may decompose and/or be converted into solid components of a lower volume than the original pre-sintered pore forming material, thereby forming pores inside the oxygen carrying particle. Alternatively, pore forming materials may be converted into gaseous or liquid components that are liberated from the oxygen carrying materials during sintering, thereby generating pores. The pore forming materials selected for this purpose may include H₂O, carbon, organic compounds, as well as carbonates, bicarbonates, hydroxides, phosphates, chlorides, sulfides of Ca, Mg, Fe, Cu, Mn, Co, Cr, Ba, Sr, Zn, Cd, Ag, Au, Mo or combinations thereof. The pore forming materials may comprise between about 0% and about 70%, about 0% to about 50%, about 0% to about 30%, about 10% to about 60%, or about 10% to about 30% by weight of the pre-sintered mixture.

The result of this mixing process may be a mixture comprising powders of active mass precursor, inert material precursor, and other optional mixture additives such as support material precursor. As used herein, a “precursor” material is the material of the oxygen carrying particle prior to sintering. If the mixture is wet, the mixture may be dried, such as by heating at temperatures of less than about 500° C., or any elevated temperature sufficient to dry to the mixture. The mixture may be processed into desired shapes and sizes, such as particles. Particles may be formed by fabrication techniques including, but not limited to, extrusion, pelletization, granulation, solution/slurry combustion, and combinations thereof. To facilitate the particle formation process from powder mixture, certain materials may be added to the powder mixture. These materials may be binder materials such as, but not limited to, starch, glucose, sucrose, clay, ceramic materials or a combination thereof, or lubricants such as, but not limited to, magnesium stearate, licowax, or combinations thereof. Binders and lubricants may be added to the powder mixture. The weight percentage of the combination of the binder and lubricant materials may range from about 1% to about 20% by weight of the pre-sintered mixture.

The formed mixture may then be heated, such that the inert structure precursor may be sintered for a time and at a temperature sufficient to sinter the inert material precursor to form a high-strength inert structure. In one embodiment, the sintering temperature may be greater than 1100° C., greater than 1150° C., greater than 1200° C., greater than 1250° C., greater than 1300° C., greater than 1350° C., greater than 1400° C., greater than 1450° C., or even greater than 1500° C. The sintering temperature may be less than 1900° C., but may be higher. In one embodiment, the sintering temperature may be between about 1100° C. and about 1400° C., between about 1150° C. and about 1400° C., or between about 1200° C. and about 1400° C. In yet another embodiment, the sintering temperatures may be greater than 1300° C. and less than about 1900° C., greater than 1350° C. and less than about 1900° C., greater than about 1400° C. and less than about 1900° C., or greater than about 1500° C. and less than about 1900° C. The purpose of such high sintering temperatures is to sinter the inert structure precursor into a strong frame, such as a ceramic frame, which may sustain the physical strength of the oxygen carrying particle throughout cyclic chemical looping reactions.

In another embodiment, oxygen carrying material particle fines may be produced by use of the oxygen carrying material in reactor systems, such as chemical looping systems. If fines of oxygen carrying particles are generated from the chemical looping unit, they may be reused to make the oxygen carrying particles. The fines may be mixed with fresh oxygen carrying powder using techniques including mechanical mixing, slurry mixing, impregnation, sol-gel, co-precipitation, solution combustion, or combinations thereof. The fresh powder and fine material may be mixed in any proportion, or fines may be utilized to make new particles with no addition of fresh materials. The mixture is then processed through the other synthesis steps described herein to form the oxygen carrying particle with desired particle size, reactivity, and strength.

To compensate for the loss in surface area and pore volume due to the high temperature sintering, an activation step may be applied to activate the densified oxygen carrying particles to its desired working reactivity. A highly-sintered oxygen carrying particle may be activated through cyclic reduction and oxidation reactions. During the cyclic reactions, the crystal structure and volume of the active mass, such as one or more metal oxides, undergoes cyclic changes, which gradually create interior defects and pores in the oxygen carrying particles. The generated defects and pores may improve the reactivity of the oxygen carrying material in the chemical looping reactions. The defects and pores in the oxygen carrying particles may enhance the reactivity of oxygen carrying particles for the desired chemical looping reactions. This activation step utilizes the cyclic crystal structure change and volume change of the active mass that occur in the cyclic reduction and oxidation reactions to create defects and pores in the oxygen carrying particle. However, the high-strength inert structure formed by the aforementioned high-temperature sintering is less affected or is not affected at all since it is inert to cyclic redox reactions.

In one embodiment, the activation step can be performed in the chemical looping reactors during normal operation. In another embodiment, the activation step can be performed in a separate apparatus. The highly-densified oxygen carrying material may be oxidized and reduced cyclically with reducing agents and oxidizing agents, such as, but not limited to, H₂, CO, CH₄, or combinations thereof as reducing agents, and steam, O₂, CO₂, or combination thereof as oxidizing agents. In various embodiments, 0 vol % to 90 vol % of inert gas may be mixed with the reducing and oxidizing agents, respectively. Optionally, inert gas may be utilized to flush the system between reduction and oxidation reactions. Examples of inert gases include N₂, Ar, He, Kr, Ne, Xe, Rn, or combinations thereof. The time of each reduction or oxidation step of the activation can vary from about 0.1 hour to about 5 hours. The number of reduction and oxidation cycles in the activation step may vary from 1 to 200 cycles.

In one embodiment, the oxygen carrying materials described herein may display superior strength. For example, in one embodiment, an oxygen carrying material may have a pre-activation compression strength of greater than about 60 N, greater than about 80 N, greater than about 100 N, or even greater than about 120 N. As used herein, “pre-activation compression strength” is measured by forming the oxygen carrying material into a 2 mm spherical particle and pressing them between two plates until the particle breaks, wherein the compression strength is the highest recorded force applied during the test. In another embodiment, the oxygen carrying material may have a post-activation compression strength of greater than about 20 N, greater than about 30 N, greater than about 40 N, or even greater than about 50 N. As used herein, “post-activation compression strength” is measured by forming the oxygen carrying material into a 2 mm spherical particle, then activating the particle by reacting the particles for 200 redox cycles, and then performing the test outlined above, where the compression strength is the highest recorded force. In another embodiment, the activation of the oxygen carrying materials may not decrease the compression strength of the oxygen carrying materials by more than about 60%, more than about 70%, or even more than about 80%.

Generally, oxygen carrying materials that may be used in systems for converting fuel by redox reactions of oxygen carrying material particles. Further details regarding the operation of fuel conversion systems are described in Thomas (U.S. Pat. No. 7,767,191), Fan (PCT/US10/48125), Fan (WO 2010/037011), and Fan (WO 2007/082089), all of which are incorporated herein by reference in their entirety. Additionally, provided herein are example embodiments of chemical looping processes and systems that may utilize the oxygen carrying materials described herein. While various systems for converting fuel in which an oxygen carrying materials may be utilized are described herein, it should be understood that the oxygen carrying materials described herein may be used in a wide variety of fuel conversion systems, such as those disclosed herein as well as others. It should also be understood that the oxygen carrying materials described herein may be used in any system which may utilize an oxygen carrying material. It should further be understood that while several fuel conversion systems that utilize an iron containing oxygen carrying material are described herein, the oxygen carrying material need not contain iron, and the reaction mechanisms described herein in the context of an iron containing oxygen carrying material may be illustrative to describe the oxidation states of oxygen carrying materials that do not contain iron throughout the fuel conversion process.

For example, in some embodiments, a reactor system may utilize a chemical looping process wherein carbonaceous fuels may be converted to heat, power, chemicals, liquid fuels, CO, and/or hydrogen (H₂). In the process of converting carbonaceous fuels, oxygen carrying materials within the system such as oxygen carrying particles may undergo reduction/oxidation cycles. The carbonaceous fuels may reduce the oxygen carrying materials in a reduction reactor. The reduced oxygen carrying materials may then be oxidized by steam and/or air in one or more separate reactors. In some embodiments, oxides of iron may be exemplary as at least one of the components in the oxygen carrying materials in the chemical looping system. In some embodiments, oxides of copper, cobalt and manganese may also be utilized in the system.

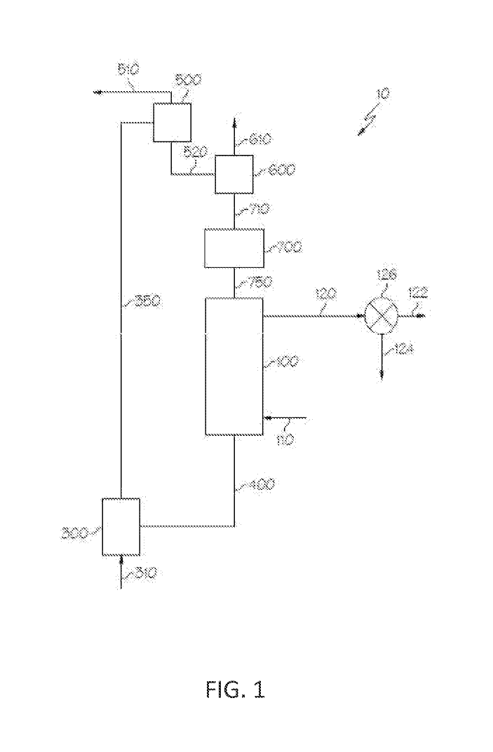

Now referring to FIG. 1, embodiments of the systems described herein may be directed to a specific configuration wherein heat and/or power may be produced from solid carbonaceous fuels. In such a fuel conversion system 10, a reduction reactor 100 may be used to convert the carbonaceous fuels from an inlet stream 110 into a CO₂/H₂O rich gas in an outlet stream 120 using oxygen carrying materials. Oxygen carrying materials that enter the reduction reactor 100 from the solids storage vessel 700 through connection means 750 may contain oxides of iron with an iron valence state of 3+. Following reactions which take place in the reduction reactor 100, the metal such as Fe in the oxygen carrying material may be reduced to an average valence state between about 0 and 3+.

The oxygen carrying materials may be fed to the reactor via any suitable solids delivery device/mechanism. These solid delivery devices may include, but are not limited to, pneumatic devices, conveyors, lock hoppers, or the like.

The reduction reactor 100 generally may receive a fuel, which is utilized to reduce at least one metal oxide of the oxygen carrying material to produce a reduced metal or a reduced metal oxide. As defined herein, “fuel” may include: a solid carbonaceous composition such as coal, tars, oil shales, oil sands, tar sand, biomass, wax, coke etc; a liquid carbonaceous composition such as gasoline, oil, petroleum, diesel, jet fuel, ethanol etc; and a gaseous composition such as syngas, carbon monoxide, hydrogen, methane, gaseous hydrocarbon gases (C1-C6), hydrocarbon vapors, etc. For example, and not by way of limitation, the following equation illustrates possible reduction reactions:

Fe₂O₃+2CO→2Fe+2CO₂

16Fe₂O₃+3C₅H₁₂→32Fe+15CO₂+18H₂O

In this example, the metal oxide of the oxygen carrying material, Fe₂O₃, is reduced by a fuel, for example, CO, to produce a reduced metal oxide, Fe. Although Fe may be the predominant reduced composition produced in the reduction reaction of the reduction reactor 100, FeO or other reduced metal oxides with a higher oxidation state are also contemplated herein.

The reduction reactor 100 may be configured as a moving bed reactor, a series of fluidized bed reactors, a rotary kiln, a fixed bed reactor, combinations thereof, or others known to one of ordinary skill in the art. Typically, the reduction reactor 100 may operate at a temperature in the range of about 400° C. to about 1200° C. and a pressure in the range of about 1 atm to about 150 atm; however, temperatures and pressures outside these ranges may be desirable depending on the reaction mechanism and the components of the reaction mechanism.

The CO₂/H₂O rich gas of the outlet stream 120 may be further separated by a condenser 126 to produce a CO₂ rich gas stream 122 and an H₂O rich stream 124. The CO₂ rich gas stream 122 may be further compressed for sequestration. The reduction reactor 100 may be specially designed for solids and/or gas handling, which is discussed herein. In some embodiments, the reduction reactor 100 may be configured as a packed moving bed reactor. In another embodiment, the reduction reactor may be configured as a series of interconnected fluidized bed reactors, wherein oxygen carrying material may flow counter-currently with respect to a gaseous species.

Still referring to FIG. 1, the reduced oxygen carrying materials exiting the reduction reactor 100 may flow through a combustion reactor inlet stream 400 and may be transferred to a combustion reactor 300. The reduced oxygen carrying material in the combustion reactor inlet stream 400 may be moved through a non-mechanical gas seal and/or a non-mechanical solids flow rate control device along the stream 400 between the reduction reactor 100 and combustion reactor 300.

To regenerate the metal oxide of the oxygen carrying materials, the system 10 may utilize a combustion reactor 300, which is configured to oxidize the reduced metal oxide. The oxygen carrying material may enter the combustion reactor 300 and may be fluidized with air or another oxidizing gas from an inlet stream 310. The iron in the oxygen carrying material may be re-oxidized by air in the combustion reactor 300 to an average valence state of about 3+. The combustion reactor 300 may release heat during the oxidation of oxygen carrying material particles. Such heat may be extracted for steam and/or power generation. In some embodiments, the combustion reactor 300 may comprise an air filled line or tube used to oxidize the metal oxide. Alternatively, the combustion reactor 300 may be a heat recovery unit such as a reaction vessel or other reaction tank.

The following equation lists one possible mechanism for the oxidation in the combustion reactor 300:

2Fe₃O₄+0.50₂→3Fe₂O₃

Following the oxidation reaction in the combustion reactor 300, the oxidized oxygen carrying materials may be transferred to a gas-solid separation device 500. The gas-solid separation device 500 may separate gas and fine particulates in an outlet stream 510 from the bulk oxygen carrying material solids in an outlet stream 520. The oxygen carrying material may be transported from the combustion reactor 300 to the gas-solid separation device 500 through solid conveying system 350, such as for example a riser. In one embodiment, the oxygen carrying material may be oxidized to Fe₂O₃ in the solid conveying system 350.

The bulk oxygen carrying material solids discharged from the gas-solid separation device 500 may be moved through a solids separation device 600, through connection means 710, and to a solids storage vessel 700 where substantially no reaction is carried out. In the solids separation device 600, oxygen carrying materials may be separated from other solids, which flow out of the system through an outlet 610. The oxygen carrying material solids discharged from the solids storage vessel 700 may pass through a connection means 750 which may include another non-mechanical gas sealing device and finally return to the reduction reactor 100 to complete a global solids circulation loop.

In some embodiments, the oxygen carrying material particles may undergo numerous regeneration cycles, for example, 10 or more regeneration cycles, and even greater than 100 regeneration cycles, without substantially losing functionality. This system may be used with existing systems involving minimal design change.

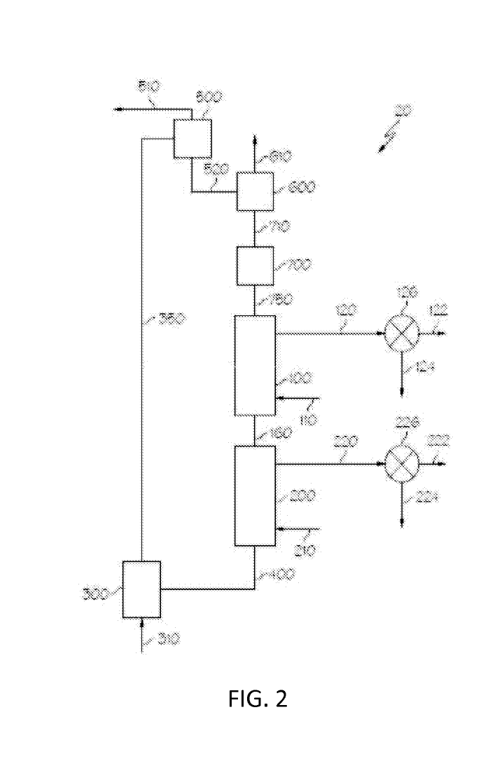

Now referring to FIG. 2, in another embodiment, H₂ and/or heat/power may be produced from solid carbonaceous fuels by a fuel conversion system 20 similar to the system 10 described in FIG. 1, but further comprising an oxidation reactor 200. The configuration of the reduction reactor 100 and other system components in this embodiment follows the similar configuration as the previous embodiment shown in FIG. 1. The system of FIG. 2 may convert carbonaceous fuels from the reduction reactor inlet stream 110 into a CO₂/H₂O rich gas stream 120 using the oxygen carrying materials that contain iron oxide with a valence state of about 3+. In the reduction reactor 100, the iron in the oxygen carrying material may be reduced to an average valence state between about 0 and 2+ for the H₂ production. It should be understood that the operation and configuration of the system 20 comprising an oxidation reactor 200 (a three reactor system) is similar to the operation of the system 10 not comprising an oxidation reactor (a two reactor system), and like reference numbers in FIGS. 1 and 2 correspond to like system parts.

Similar to the system of FIG. 1, the CO₂/H₂O rich gas in the outlet stream 120 of the system of FIG. 2 may be further separated by a condenser 126 to produce a CO₂ rich gas stream 122 and an H₂O rich stream 124. The CO₂ rich gas stream 122 may be further compressed for sequestration. The reduction reactor 100 may be specially designed for solids and/or gas handling, which is discussed herein. In some embodiments, the reduction reactor 100 may be operated in as packed moving bed reactor. In another embodiment, the reduction reactor may be operated as a series of interconnected fluidized bed reactors, wherein oxygen carrying material may flow counter-currently with respect to a gaseous species.

The reduced oxygen carrying material exiting the reduction reactor 100 may be transferred, through a connection means 160, which may include a non-mechanical gas-sealing device 160, to an oxidation reactor 200. The reduced oxygen carrying materials may be re-oxidized with steam from an inlet stream 210. The oxidation reactor 200 may have an outlet stream 220 rich in H₂ and steam. Excessive/unconverted steam in the outlet stream 220 may be separated from the H₂ in the stream 220 with a condenser 226. An H₂ rich gas stream 222 and an H₂O rich stream 224 may be generated. The steam inlet stream 210 of the oxidation reactor 200 may come from condensed steam recycled in the system 20 from an outlet stream 124 of the reduction reactor 100.

In one embodiment, a portion of the solid carbonaceous fuel in the reduction reactor 100 may be intentionally or unintentionally introduced to the oxidation reactor 200, which may result in a H₂, CO, and CO₂ containing gas in an outlet stream 220. Such a gas stream 220 can be either used directly as synthetic gas (syngas) or separated into various streams of pure products. In the oxidation reactor 200, the reduced oxygen carrying materials may be partially re-oxidized to an average valence state for iron that is between 0 and 3+. In some embodiments, the reduction reactor 100 is configured to operate in a packed moving bed mode or as a series of interconnected fluidized bed reactors, in which oxygen carrying material may flow counter-currently with respect to the gaseous species.

The oxidation reactor 200, which may comprise the same reactor type or a different reactor type than the reduction reactor 100, may be configured to oxidize the reduced metal or reduced metal oxide to produce a metal oxide intermediate. As used herein, “metal oxide intermediate” refers to a metal oxide having a higher oxidation state than the reduced metal or metal oxide, and a lower oxidation state than the metal oxide of the oxygen carrying material. For example, and not by way of limitation, the following equation illustrates possible oxidation reactions in the oxidation reactor 200:

3Fe+4H₂O→Fe₃O₄+4H₂

3Fe−4CO₂→Fe₃O₄+4CO

In this example, oxidation in the oxidation reactor using steam may produce a resultant mixture that includes metal oxide intermediates comprising predominantly Fe₃O₄. Fe₂O₃ and FeO may also be present. Furthermore, although H₂O, specifically steam, is the oxidant in this example, numerous other oxidants are contemplated, for example, CO, O₂, air, and other oxidizing compositions.

The oxidation reactor 200 may be configured as a moving bed reactor, a series of fluidized bed reactors, a rotary kiln, a fixed bed reactor, combinations thereof, or others known to one of ordinary skill in the art. Typically, the oxidation reactor 200 may operate at a temperature in the range of about 400° C. to about 1200° C. and a pressure in the range of about 1 atm to about 150 atm; however, one of ordinary skill in the art would realize that temperatures and pressures outside these ranges may be desirable depending on the reaction mechanism and the components of the reaction mechanism.

The oxidation reactor 200 may also comprise a moving bed with a countercurrent contacting pattern of gas and solids. Steam may be introduced at the bottom of the reactor and may oxidize the reduced Fe containing particles as the particles move downwardly inside the oxidation reactor 200. In this embodiment, the product formed may be hydrogen, which is subsequently discharged from the top of the oxidation reactor 200. It will be shown in further embodiments that products such as CO and syngas are possible in addition to hydrogen. Though Fe₂O₃ formation is possible in the oxidation reactor 200, the solid product from this reactor may be mainly metal oxide intermediate, Fe₃O₄. The amount of Fe₂O₃ produced in the oxidation reactor 200 depends on the oxidant used, as well as the amount of oxidant fed to the oxidation reactor 200. The steam present in the hydrogen product of the oxidation reactor 200 may then be condensed in order to provide for a hydrogen rich stream. At least part of this hydrogen rich stream may be recycled back to the reduction reactor 100. In addition to utilizing the same reactor type as the reduction reactor 100, the oxidation reactor 200 may similarly operate at a temperature between about 400° C. to about 1200° C. and pressure of about 1 atm to about 150 atm.

Still referring to FIG. 2, the partially re-oxidized oxygen carrying materials exiting the oxidation reactor 200 may flow through a combustion reactor inlet stream 400 and may be transferred to a combustion reactor 300. The reduced oxygen carrying material in the combustion reactor inlet stream 400 may be moved through a non-mechanical gas seal and/or a non-mechanical solids flow rate control device.

Followed by the oxidation reactions in the combustion reactor 300, the oxidized oxygen carrying materials may be transferred in the same manner as the previous embodiment in FIG. 1, such as through a solid conveying system 350 such as a riser, into a gas-solid separation device 500, to a solids separation device 600, and to solids storage vessel 700.

The reactors of the systems described herein may be constructed with various durable materials suitable to withstand temperatures of up at least 1200° C. The reactors may comprise carbon steel with a layer of refractory on the inside to minimize heat loss. This construction also allows the surface temperature of the reactor to be fairly low, thereby improving the creep resistance of the carbon steel. Other alloys suitable for the environments existing in various reactors may also be employed, especially if they are used as internal components configured to aid in solids flow or to enhance heat transfer within a moving bed embodiment. The interconnects for the various reactors can be of lock hopper design or rotary/star valve design to provide for a good seal. However, other interconnects as can be used.

Various mechanisms can be used for solid transportation in the numerous systems disclosed herein. For example, in some embodiments the solid transportations systems described herein may be transport systems using a pneumatic conveyor driven by air, belt conveyors, bucket elevators, screw conveyors, moving beds and fluidized bed reactors. The resultant depleted air stream may be separated from the particles and its high-grade-heat content recovered for steam production. After regeneration, the oxygen carrying material particle may not be substantially degraded and may maintain full particle functionality and activity.

Heat integration and heat recovery within the system and all system components may be desirable. Heat integration in the system is specifically focused on generating the steam for the steam requirements of the oxidation reactor 200. This steam may be generated using the high grade heat available in the hydrogen, CO₂ and depleted air streams exiting the various system reactors 100, 200, 300, respectively. In one embodiment of the processes described herein, substantially pure oxygen may be generated, in which part of the hydrogen may be utilized. The residence time in each reactor is dependent upon the size and composition of individual oxygen carrying material particles. For example, the residence time for a reactor comprising Fe based metal oxides may range from about 0.1 to about 20 hours.

In some embodiments, additional unwanted elements may be present in the system. Trace elements like Hg, As, Se are not expected to react with Fe₂O₃ at the high temperatures of the process. As a result they are expected to be present in the CO₂ stream produced. If CO₂ is to be used as a marketable product, these trace elements may be removed from the stream. Various cleanup units, such as mercury removal units are contemplated herein. Similar options will need to be exercised in case the CO₂ stream is let out into the atmosphere, depending upon the rules and regulations existing at that time. If it is decided to sequester the CO₂ for long term benign storage, e.g. in a deep geological formation, there may not be a need to remove these unwanted elements. Moreover, CO₂ may be sequestered via mineral sequestration, which may be more desirable than geological storage, because it may be safer and more manageable.

Furthermore, sulfur may constitute an unwanted element, which must be accounted for in the system. In a solid fuel conversion embodiment, sulfur, which is present in coal, is expected to react with Fe₂O₃ and form FeS. Some FeS may release SO₂ in the combustion reactor 300. This will be liberated on reaction with steam in the oxidation reactor 300 as H₂S and will contaminate the hydrogen stream. During the condensation of water from this steam, most of this H₂S will condense out. The remaining H₂S can be removed using conventional techniques like amine scrubbing or high temperature removal using a Zn, Fe or a Cu based sorbent. Another method for removing sulfur may include the introduction of sorbents, for example, CaO, MgO, etc. Additionally, sorbents may be introduced into the reduction reactor 100 in order to remove the sulfur and to prevent its association with Fe. The sorbents may be removed from the system using ash separation device.

Although some embodiments of the present system are directed to producing hydrogen, it may be desirable for further treatment to produce ultra-high purity hydrogen. As would be familiar to one of ordinary skill in the art, some carbon or its derivatives may carry over from the reduction reactor 100 to the oxidation reactor 200 and contaminate the hydrogen stream. Depending upon the purity of the hydrogen required, it may be desirable to use a pressure swing adsorption (PSA) unit for hydrogen to achieve ultra-high purities. The off gas from the PSA unit may comprise value as a fuel and may be recycled into the reduction reactor 100 along with coal, in solid fuel conversion embodiments, in order to improve the efficiency of hydrogen production in the system.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

### EXAMPLES

The various embodiments of oxygen carrying materials will be further clarified by the following examples. The examples are illustrative in nature, and should not be understood to limit the subject matter of the present disclosure.

### Example 1

Oxygen carrying materials were prepared with varying compositions and sintered at varying times and temperatures. Component powders were well mixed with water, which was stirred to achieve a homogenous slurry mixture. The slurry was then dried at 100° C. and subsequently ground into fine powder, which was subsequently granulated into 2 mm spherical particles. The particles were then sintered. Table 1, shown below, lists several sample embodiments of oxygen carrying materials described herein, as well as some comparative examples of conventional oxygen carrying materials. Table 1 lists precursor materials by weight percentage and sintering conditions for various embodiments.

TABLE 1

| | | | | Sinter | |
|---|---|---|---|---|---|
| | | | | temper- | Sinter |
| | Active | Inert | Support | ature | time |
| Sample | mass | material(s) | material(s) | (° C.) | (hours) |
| A | 50 wt % | 20 wt % | 30 wt % | 1400 | 2 |
| | Fe₂O₃ | Calcium | TiO₂ | | |
| | | Aluminate | | | |
| Compar- | 50 wt % | none | 50 wt % | 1400 | 2 |
| ative Ex- | Fe₂O₃ | | TiO₂ | | |
| ample B | | | | | |
| Compar- | 50 wt % | 20 wt % | 30 wt % | 1000 | 2 |
| ative Ex- | Fe₂O₃ | Calcium | TiO₂ | | |
| ample C | | Aluminate | | | |
| D | 20 wt % | 40 wt % | 20 wt % | 1400 | 3 |
| | Fe₂O₃ and | Ca₃SiO₅ | TiO₂ | | |
| | 20 wt % | | | | |
| | Ni₂O₃ | | | | |
| E | 40 wt % | 40 wt % | 20 wt % | 1300 | 1 |
| | Fe₂O₃ | Calcium | TiO₂ | | |
| | | Aluminate | | | |
| F | 40 wt % | 60 wt % | none | 1200 | 1 |
| | CuO | Calcium | | | |
| | | Aluminate | | | |
| G | 50 wt % | 35 wt % | 10 wt % | 1300 | 2 |
| | Fe₂O₃ | Calcium | TiO₂ and | | |
| | | Aluminate | 5 wt % | | |
| | | | MgO | | |
| H | 40 wt % | 20 wt % | 20 wt % | 1300 | 3 |
| | Fe₂O₃ | Calcium | TiO₂ | | |
| | | Aluminate and | | | |
| | | 20 wt % | | | |
| | | Magnesium | | | |
| | | Aluminate | | | |
| I | 20 wt % | 75 wt % | 5 wt % | 1100 | 4 |
| | Mn₂O₃ | Ca₃SiO₅ | MgO | | |
| J | 20 wt % | 65 wt % | 10 wt % | 1300 | 2 |
| | Fe₂O₃ | Calcium | TiO₂ and | | |
| | | Aluminate | 5 wt % | | |
| | | | MgO | | |

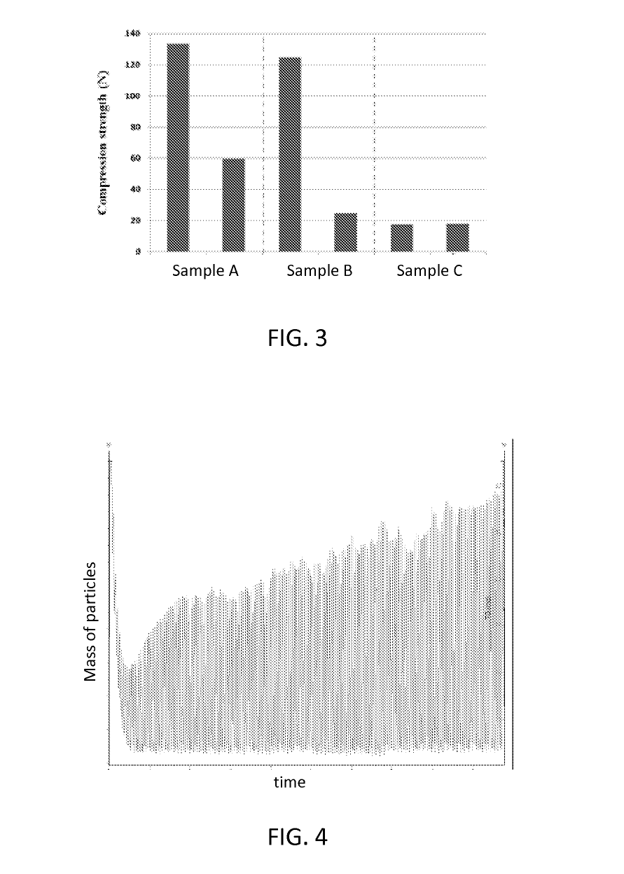

Referring now to FIG. 3, compression strength was measured for Sample A, Sample B, and Sample C, wherein the compression strength for each sample was observed before 200 redox cycles and after 200 redox cycles (the activation step). For each respective sample, the bar on the left represents compression strength before 200 redox cycles and the bar on the right represents compression strength after 200 redox cycles. Sample A is representative of an oxygen carrying material as described herein comprising a high-strength inert structure. Sample B and Sample C represent conventional oxygen carrying particles, where Sample B does not contain an inert refractory material, and where Sample C is sintered at a relatively low temperature, 1000° C. As shown in FIG. 3, Sample A had higher strength than Sample B and Sample C, both prior to the 200 redox cycles and following 200 redox cycles. By comparing Sample A and Sample B, it is observed that the presence of an inert material affects the strength of the oxygen carrying material following redox cyclic reactions. While both Sample A and Sample B lose some strength over the 200 cycles, Sample A, which comprises a high-strength inert structure has much less strength loss than Sample B, which is sintered at high temperatures but does not comprise an inert material capable of forming the high-strength inert structure. Sample C, which is identical in precursor composition to Sample A is sintered at a relatively low temperature, has much lower strength than Sample A. A comparison of Sample A to Sample C shows that only at a relatively high sintering temperature can make the inert structure precursor material solidify into a high-strength inert structure which increases and sustains the strength of the particle.

Now referring to FIG. 4, redox reactivity was measured for Sample A, where the x-axis measures time and the y-axis measures the mass of a sample particle, which loses and gains oxygen atoms with each redox cycle. The reactivity is shown to increase over continuing redox cycles performed at 900° C., which, without being bound by theory, is believed to be caused by pores and/or other deformations being created in the oxygen carrying material. This corresponds to the activation step described herein. In view of FIGS. 3 and 4, the oxygen carrying particles described herein have higher strength as compared with conventional oxygen carrying particles, yet are sufficiently reactive to cyclic oxidation and reduction reactions.

### Example 2

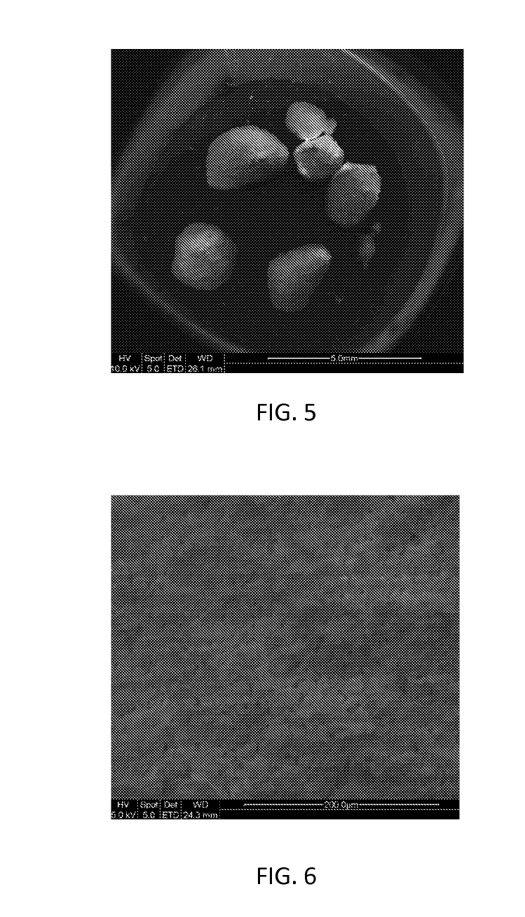

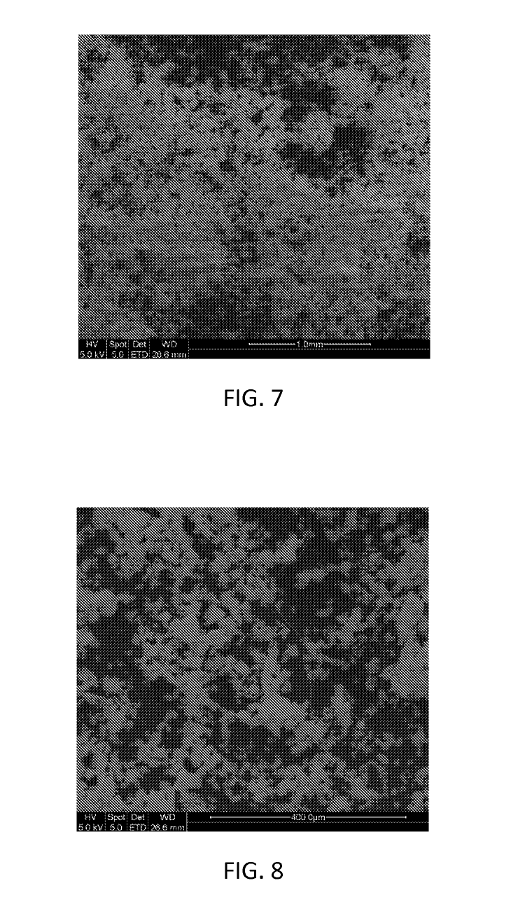

Calcium aluminate particles, made by mixing fine powders and water into a mixture that was granulated to 1 mm to 3 mm in size, were sintered at 900° C. and 1400° C. for two hours, respectively. FIGS. 5 and 6 show microscopic images of particles sintered at 1400° C. and FIGS. 7 and 8 show microscopic images of particles sintered at 900° C. As shown in FIGS. 7 and 8, the particles sintered at 900° C. either directly break back to fine power or easily crumble into fine powder with small amounts of applied pressure, such as the pressure from prodding tweezers. However, now referring to FIGS. 5 and 6, the 1400° C. sintered particles still maintain particle integrity and gain much higher compression strength than the un-sintered precursor particles. FIG. 6 shows the initial fine particles are sintered together to form a strong structure. FIGS. 5-8 are illustrative of the high temperature sintering necessary to densify inert refractory materials, such as calcium aluminate, that may form the high-strength inert structures of the oxygen carrying materials described herein.

1. A method for producing an oxygen carrying material, the method comprising:
forming a mixture comprising powders of active mass precursor, support material precursor, and inert structure precursor, wherein:
the active mass precursor comprises metals, metal oxides, or combinations thereof;
the support material precursor comprises one or more components selected from the group consisting of metals, ceramics, metal oxides, metal carbides, metal nitrates, metal halides, clays, ores, and combinations thereof;
the inert structure precursor comprises one or more refractory ceramic components selected from the group consisting of silicon carbide, calcium aluminate, magnesium aluminate, aluminum silicate, chromium sulfate, magnesium oxide, aluminum silicate, magnesium silicate, and combinations thereof;
the active mass precursor, the support material precursor, and the inert structure precursor are different compositionally; and
producing the oxygen carrying material by heating the mixture at a temperature of greater than 1300° C. for a time sufficient to sinter the inert structure precursor to form a high-strength inert structure.

2. The method of claim 1, wherein the heating is at a temperature greater than 1400° C.

3. The method of claim 1, wherein the heating is at a temperature between 1300° C. and 1900° C.

4. The method of claim 1, further comprising activating the oxygen carrying material by oxidizing and reducing the oxygen carrying material prior to use in a chemical reactor system.

5. The method of claim 1, wherein the mixture further comprises a pore forming material.

6. The method of claim 5, wherein the pore forming material is selected from:
H₂O, carbon, organic compounds, or combinations thereof; or
carbonates, bicarbonates, hydroxides, phosphates, chlorides, sulfides of Ca, Mg, Fe, Cu, Mn, Ni, Co, Cr, Ba, Sr, Zn, Cd, Ag, Au, Mo, or combinations thereof.

7. The method of claim 1, further comprising shaping the mixture to the form of a particle between about 0.5 mm and about 10 mm in diameter.

8. The method of claim 1, wherein:
the metal or metal oxide of the active mass precursor is selected from Fe, Co, Ni, Cu, Mo, Mn, Sn, Ru, Rh, oxides thereof, and combinations thereof;
the support material precursor is selected from metals or metal oxides of Ti, Mg, and combinations thereof; and
the inert structure precursor is selected from calcium aluminate, calcium silicate, magnesium aluminate, and combinations thereof.

9. An oxygen carrying material comprising an active mass, a support material, and a high-strength inert structure, wherein:
the active mass comprises metals, metal oxides, or combinations thereof;
the support material comprises one or more components selected from the group consisting of metals, ceramics, metal oxides, metal carbides, metal nitrates, metal halides, clays, ores, and combinations thereof;
the high-strength inert structure comprises one or more refractory ceramic components in the form of a high-density solid framework operable to impart mechanical strength to the oxygen carrying material; and
the one or more refractory ceramic components is selected from the group consisting of silicon carbide, calcium aluminate, magnesium aluminate, aluminum silicate, chromium sulfate, magnesium oxide, aluminum silicate, magnesium silicate, and combinations thereof.

10. The oxygen carrying material of claim 9, wherein the metal oxide is selected from Fe, Co, Ni, Cu, Mo, Mn, Sn, Ru, Rh, oxides thereof, and combinations thereof.

11. The oxygen carrying material of claim 9, wherein the oxygen carrying material is in the form of a particle.

12. The oxygen carrying material of claim 11, wherein each particle is between about 0.5 mm and about 10 mm in diameter.

13. The oxygen carrying material of claim 9, further comprising pores.

14. The oxygen carrying material of claim 9, wherein the oxygen carrying material is in the form of a particle between about 0.5 mm and about 10 mm in diameter.

15. The oxygen carrying material of claim 9, wherein:
the metal or metal oxide of the active mass is selected from Fe, Co, Ni, Cu, Mo, Mn, Sn, Ru, Rh, oxides thereof, and combinations thereof;
the support material is selected from metals or metal oxides of Ti, Mg, and combinations thereof; and
the material of the high-strength inert structure is selected from calcium aluminate, calcium silicate, magnesium aluminate, and combinations thereof.

16. The oxygen carrying material of claim 9, wherein the oxygen carrying material has a pre-activation compression strength of greater than about 60 N.

17. The oxygen carrying material of claim 9, wherein the oxygen carrying material has a post-activation compression strength of greater than about 40 N.

18. The oxygen carrying material of claim 9, wherein activation of the oxygen carrying materials does not decrease the compression strength of the oxygen carrying materials by more than about 70%

19. A method for producing an oxygen carrying material, the method comprising:
forming a mixture comprising powders of active mass precursor, support material precursor, and inert structure precursor, wherein:
the active mass precursor comprises metals, metal oxides, or combinations thereof;
the support material comprises one or more components selected from the group consisting of metals, ceramics, metal oxides, metal carbides, metal nitrates, metal halides, clays, ores, and combinations thereof;
the inert structure precursor comprises one or more refractory ceramic components selected from the group consisting of silicon carbide, calcium aluminate, magnesium aluminate, aluminum silicate, chromium sulfate, magnesium oxide, aluminum silicate, magnesium silicate, and combinations thereof;
the active mass precursor, the support material precursor, and the inert structure precursor are different compositionally; and
producing the oxygen carrying material by heating the mixture at a temperature between about 1100° and about 1400° C. for a time sufficient to sinter the inert structure precursor to form a high-strength inert structure.

20. The method of claim 19, wherein the mixture further comprises a pore forming material selected from:
H₂O, carbon, organic compounds, or combinations thereof; or
carbonates, bicarbonates, hydroxides, phosphates, chlorides, sulfides of Ca, Mg, Fe, Cu, Mn, Ni, Co, Cr, Ba, Sr, Zn, Cd, Ag, Au, Mo, or combinations thereof.
